(19) United States
(12) Patent Application Publication
(10) Pub. No.: US 2007/0230695 A1
(43) Pub. Date: Oct. 4, 2007

(54) APPARATUS AND METHOD FOR GENERATING A NUMBER WITH RANDOM DISTRIBUTION

(75) Inventors: NIKOLAI SEFZIK, Markt Schwaben (DE); FRANZ KLUG, Munich (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Munich (DE)

(21) Appl. No.: 11/688,472

(22) Filed: Mar. 20, 2007

(30) Foreign Application Priority Data
Mar. 20, 2006 (DE) 10 2006 012 635.1

(51) Int. Cl. H04L 9/00

(52) U.S. Cl. 380/46

(57) ABSTRACT

An apparatus for providing a number with random distribution for use in a circuit including a signal processor processing encrypted data. The apparatus includes a unit formed to provide the number from at least a portion of the encrypted data processed by the signal processor.

### CROSS-REFERENCE TO RELATED APPLICATION

This application claims priority from German Patent Application No. 10 2006 012 635.1, which was filed on Mar. 20, 2006, and is incorporated herein by reference in its entirety.

### TECHNICAL FIELD

The present invention relates to an apparatus and a method for generating a number with random distribution, specifically to an apparatus as used for example in the context of a microcontroller, a chip card (smart card) or any other processors, that are dependent on numbers with random distribution for example in the context of cryptographic methods and processes.

### BACKGROUND

Many cryptographic methods demand numbers with random distribution such as random numbers or pseudorandom numbers so as to be able to provide sufficient security. Here pseudorandom numbers are generated by so-called pseudorandom number generators, which provide a sequence of pseudorandom numbers, starting from a seed, by an application of a deterministic method. Depending on the method used and the pseudorandom number generator used, the sequence of pseudorandom numbers exhibits different quality with respect to statistical and/or cryptographic properties.

Seeds are also widely used for the systematic variation of pseudorandom number generators (PRNGs) in order to break the existing deterministic behaviour of the pseudorandom number generators. Based on the deterministic behaviour of the pseudorandom number generators, the sequence of pseudorandom numbers among other things has a fixed order or sequence. In addition, most sequences of pseudorandom numbers of a pseudorandom number generator exhibit a certain periodicity, that is, the sequence of pseudorandom numbers is recurring.

Thus a change of the seed results in leaving the sequence of pseudorandom numbers and continuing the same at another location. One possible approach might be to add such seeds to an LFSR (linear feedback register) or other shift registers with feedback so as to obtain new initial values in a sequence. However, in order to be able to realize this safely, a source with a statistically balanced randomness is demanded. The same has been implemented with controllers and other microprocessors either in the context of a true random number generator (TRNG) or a hardware pseudorandom number generator.

Previous approaches have used a certain number of flip-flops, typically more than ten flip-flops, in order to store a random value of a true random number generator therein. This value is then compared to a deterministic value of a pseudorandom number generator. In the case of an identity of the two values, a subsequent random value of the true random number generator is then used as a seed for the pseudorandom number generator. The size of the number of flip-flops used helps to control the frequency of a change of the seed, which is also referred to as seeding, in power-off-two steps. This, however, calls for a permanent usage of the true random number generator, which involves substantial disadvantages. Among them are particularly the substantial energy consumption caused by the use of a true random number source. Thus, often noisy resistors or voltage-controlled oscillators (VCOs) which also have with noise sources applied to their input sides are used as true random number generators in the context of microcontrollers and other processors. However, these systems have high-energy consumption compared to the energy consumption of a typical microcontroller, as it is used in the context of a chip card. Due to the need of a permanent use of the random number source in the context of the approach outlined above, this problem is becoming increasingly critical.

In addition, this approach demands substantial additional hardware expenditure for the flip-flops so as to perform a comparison of the deterministic value of the pseudorandom number generator with the random numbers of the true random number generator in the context of a random number history.

### BRIEF DESCRIPTION OF THE DRAWING

Embodiments of the present invention will be discussed in greater detail in the following with reference to the accompanying drawing.

FIG. 1 is a block diagram of a chip card with an embodiment of an inventive apparatus for providing a number with random distribution.

### DETAILED DESCRIPTION

According to an embodiment, an apparatus for providing a number with random distribution for use in a circuit including a signal processor processing the encrypted data may have: a unit designed to provide the number from at least a portion of the encrypted data processed by the signal processor.

According to another embodiment, a signal processor may receive the encrypted data and may include an apparatus for providing a number with random distribution as mentioned above.

According to another embodiment, a method for providing a number with random distribution for use in a circuit including a signal processor processing encrypted data may have the steps of: generating the number from at least a portion of the encrypted data received by the data the signal processor.

According to another embodiment, a program may have: a program code for performing a method for providing a number with random distribution for use in a circuit including a signal processor processing encrypted data, having the step of: generating the number from at least a portion of the encrypted data received by the data the signal processor, when the program is run on a processor.

The inventive apparatus for providing a number with random distribution for use in a circuit including a signal processor processing encrypted data includes a unit designed to provide the number from at least a portion of the encrypted data processed by the signal processor.

The present invention is based on the finding that a number with a random distribution may be provided in an energy-optimized and space-optimized manner by obtaining the same from at least a portion of encrypted data, which are available to the inventive apparatus either directly or indirectly. Thus, the inventive apparatus specifically enables energy- and space-optimized generation of seeds for pseudorandom number generators from encrypted data sources having a statistically good, random distribution and “automatically” occurring in modern microcontroller environments. In other words, the inventive apparatus utilizes a random number source existing in smart card controllers, chip card controllers and other microcontrollers, the statistical properties of which are very good.

The data processed by the signal processor is provided by the same in an encrypted manner, for example via a read bus or output in an encrypted manner on a write bus.

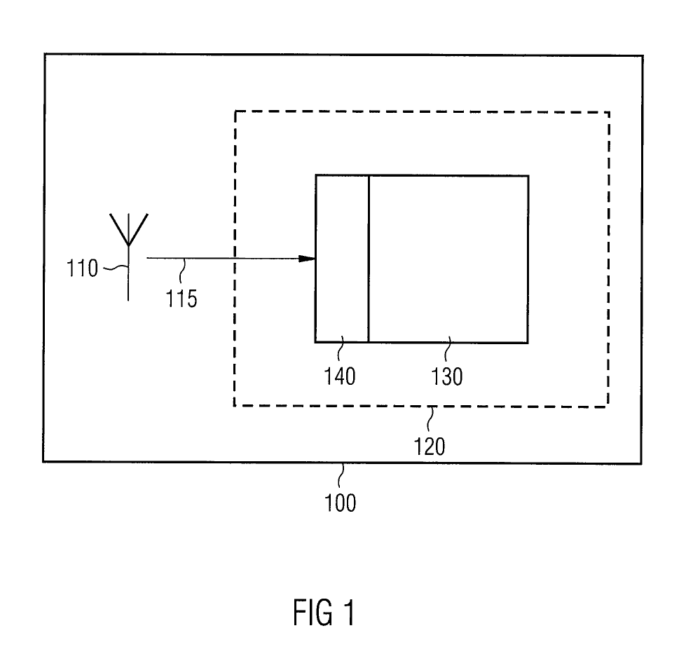

Referring to FIG. 1, an embodiment of the inventive apparatus for providing a number with random distribution, which is implemented in the context of a chip card, will be described.

FIG. 1 shows a chip card 100 with an antenna 110, via which the chip card 100 can exchange data with an external receiver not shown in FIG. 1. In addition, chip card 100 comprises a circuit 120 coupled to antenna 110 via a data bus 115, which is also referred to as interconnect, circuit 120 including a signal processor 130 and an inventive apparatus 140 for providing a number with random distribution. Antenna 110 is coupled to circuit 120 and therefore also coupled to signal processor 130 and inventive apparatus 140.

Data transmitted via antenna 110, for example between an external memory not shown in FIG. 1 and the controller and/or signal processor 130, are often hard-encrypted, for example by means of the MED3000 algorithm (MED=Memory Encryption Device). Based on the hard encryption this data exhibits good statistical properties with respect to its distribution.

In the following, the use of the inventive apparatus 140 for providing a number with random distribution in the context of a seeding, that is, in the context of providing a seed for a pseudorandom number generator included in the signal processor and/or controller 130, is to be discussed. For this purpose, the inventive apparatus 140 is connected to the pseudorandom number generator of controller 130. On the basis of a seed, the pseudorandom number generator of controller 130, as has already been discussed in the introductory sections of the present application, generates a sequence of pseudorandom numbers by the application of a deterministic method, which may also be referred to as deterministic values because of the deterministic nature of the method of their generation. It is to be understood, however, that the inventive apparatus 140 for providing a number with random distribution is not limited to the use in the context of a seeding. Thus, the inventive apparatus 140 may also provide the pseudorandom number either directly and/or by the application of a simple operation such as an XOR operation (XOR=exclusive−or) with a predetermined number or a variable number (for example of the system time) on the bit plane.

Thus, portions of this (encrypted) data may be used for a comparison with a deterministic value of a pseudorandom number generator. If for example the encrypted data has a length of m=32 bits, the lower n bits may be used for the comparison with the deterministic value of the pseudorandom number generator. In the case of the lower n bits matching the deterministic value of the pseudorandom number generator, that is, in the case of a hit, further data bits of the encrypted data which were not used in the context of the comparison, that is, such data bits that are unequal to the comparison bits, may be used as a seed for the pseudorandom number generator in the context of a seeding process. Thus, in this case for example the upper x bits of the encrypted data may be used as a seed for the pseudorandom number generator. This removes the substantial and unnecessary energetic waste incurred by the use of a true random number generator, as it has been discussed in the introductory sections of the present application. Furthermore, the comparison of portions of the encrypted data with the deterministic value of the pseudorandom number generator makes it possible to save on the additional flip-flops, that is, the additional memory locations for storing a random number history. For this purpose it is demanded, however, that in the context of the outlined example the sum of the numbers x and n be larger than the number of data bits of the encrypted data N. Here the numbers N, n and x are natural numbers.

Depending on a quantity m of the transmitted encrypted data, the following formula for calculating the probability that there will be a seeding process on the basis of the “random” values transmitted via data bus 115 arises:

$$\begin{matrix}P ( seeding ) = 1 - P ( no seeding ) \\ = 1 - P ( [ n , m ] ; X = 0 ) \\ = 1 - {[ P ( n ; X = 0 ) ]}^{m} \\ = 1 - {[ \frac{{2}^{n} - 1}{{2}^{n}} ]}^{m}\end{matrix}$$

Here, P(seeding) indicates the probability that there will be a seeding process at least once in a transfer of m encrypted data and a comparison of n bits, respectively, with a comparison value, so that there will be a seeding. Comparing n bits, respectively, with a comparison value, that is, for example a predetermined value, is an example of a predetermined condition. P(no seeding) indicates the probability that there will not be a seeding process in a transfer of m encrypted data and a comparison of n bits with a comparison value, that is, the n bits of each transferred datum do not match the comparison value in the context of the transfer of the m encrypted data. P([n, m]; x=0) further indicates the probability that none of m randomly selected values with a length of n bits have the value X=0. Due to the fact that the encrypted data transferred via data bus 115 exhibit excellent statistical distribution, thus in a very good approximation can be referred to as random values, and in addition the checks of the m random values for a presence of a certain number value X are independent of one another, this may be attributed to the probability P(n; X=0) for a deviation of a number with n bits from the value X=0.

This means that for example in a check of n=4 bits in a transfer of 16 encrypted data, it may be assumed with a probability of about 64.6%, that at least once a (random) seed will be generated on the basis of the encrypted data, which, as has been discussed above, may also be referred to as random data or random values based on their good statistical distribution.

One example of an existing source of statistically well-distributed random values in the context of modern chip card concepts, which can be used for the generation of seeds for pseudorandom number generators, is the so-called AXI read bus (AXI=Advanced extensible Interface) of the so-called AMBA architecture (AMBA=Advanced Microcontroller Bus Architecture) by Arm Ltd. Here the data transferred in an encrypted manner via the AXI read bus is used to supply the “random values” by which the seed for a mask register in the context of an APB infrastructure (APB=Advanced Periphery Bus) is generated. This may occur in combination with “random values”, which are transferred via this interconnect, both on the side of the APB bus master controlling the ABP bus and on the side of the ABP slaves, which are subordinate to the ABP bus master with respect to a hierarchy of the ABP bus.

Although in the described embodiment, data bus 115 is coupled to antenna 110, this represents no limitation referring to the present invention. Rather, data bus 115 may for example be coupled to a contact area for a data exchange between the chip card 100 and an external component via a direct metallic contact, to an infrared receiver, for example an infrared photodiode, or to any other optical receiver such as a photodiode for visible light. In addition, the inventive apparatus 140 may be coupled to an external component not only via a radio link, a direct metallic connection, an infrared link or any other optical link, but also via a corresponding internal data bus 115 connecting several components of the chip card, as long as the data transferred via this data bus 115 exhibits sufficiently high statistical distribution, for example due to encryption, for cryptographic or other applications.

The present invention is not limited to receiving and/or reading data from a read bus or a bidirectional bus. Just as little is the present invention limited to writing and/or sending data to a write bus or a bidirectional bus. In the context of the present application, all data that, due to an encryption, has sufficiently good statistical properties may be used that is processed by a circuit or any other signal processor, that is, is read or received.

In addition, the present invention is not limited to the use in chip cards. Rather, it may be employed with other electronic components such as computer systems, PCs (PC=Personal Computer), PDAs (PDA=Personal Data Assistant), data transmitter in the field of telecommunications and other electronic components having a suitable data source in the form of encrypted data and a need for numbers with statistical distribution.

In addition, in deviation from the embodiment described above, the comparison of a portion of the encrypted data with the deterministic value of the pseudorandom number generator may not only be performed by using the lower n bits of an encrypted datum for the comparison but, rather, the upper n bits, the even bits (that is, the 2nd, 4th, 6th, . . . bit of the datum), the odd bits (that is the 1st, 3rd, 5th, . . . bit of the datum) or other subsets of the data bits of the data word may also be used.

Furthermore, instead of a comparison, that is, a check for a presence of an identity of the portion of the encrypted data with the deterministic value, the presence of any other predetermined relation of the two values to each other may also be checked. A predetermined relation between the portion of the encrypted datum and the deterministic value may for example consist in the fact that both values have an identical or an inverse parity in sections, that is, with regard to one or more subsections of the values concerned.

Furthermore, the inventive apparatus may be designed such that, in the case that the portion of the encrypted data satisfies a predetermined condition, the same provides the number with the random distribution. One such predetermined condition may for example consist in the encrypted datum (in sections) satisfying a predetermined parity or several predetermined parity values. Alternatively, the predetermined condition may consist in the portion of the encrypted datum having a predetermined value.

In addition, unlike the embodiment discussed in the context of FIG. 1, the inventive apparatus may be used not only for the generation of a seed for a pseudorandom number generator, but it is basically possible to use for example the number provided by the inventive apparatus directly as a “random number” or calculate the same by a continuative operation from the number provided. Such an operation may for example consist in inverting individual bits of the number or linking the total number or portions thereof to a predetermined number or a number determined by any other way on a bit-by-bit basis in the context of an XOR operation.

Depending on the circumstances, the inventive method for providing a number with random distribution may be implemented in hardware or in software. The implementation may be effected on a digital storage medium, specifically a floppy disc, CD or DVD with electronically readable control signals, which are able to cooperate with a programmable computer system such that the inventive method for providing a number is carried out. In general, the invention thus also consists in a software program product or a computer program product or a program product with a program code for performing the inventive method stored on a machine-readable carrier, when the software program product is run on a computer or a processor. In other words, the invention may be realized as a computer program or a software program or a program with a program code for performing the method, if the program is run on a processor. The processor may be formed by a computer, a chip card (smart card) or any other integrated circuit.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. An apparatus for providing a number with random distribution for use in a circuit including a signal processor processing encrypted data, comprising:
a unit formed to provide the number from at least a portion of the encrypted data processed by the signal processor.

2. The apparatus according to claim 1, wherein the signal processor receives the encrypted data from a read bus or a bidirectional data bus or writes the encrypted data to a write bus or the bidirectional data bus.

3. The apparatus according to claim 1, wherein the encrypted data comprises a bit sequence and the unit is formed to provide the number as a first subset of the bit sequence.

4. The apparatus according to claim 1, wherein the unit is formed to provide the number from at least a portion of the encrypted data, if the encrypted data satisfies a predetermined condition or the encrypted data and a comparison value exhibit a predetermined relation to each other.

5. The apparatus according to claim 4, wherein the encrypted data comprises a bit sequence with a first subset and a second subset, each bit of the bit sequence not simultaneously belonging to the first subset and the second subset of the bit sequence,
wherein the predetermined relation either exists in the second subset of the bit sequence matching the comparison value, or the predetermined condition exists in the second subset of the bit sequence comprising a predetermined feature, and
the unit is further formed to provide the first subset of the bit sequence as a number in the case of the presence of the predetermined relation and/or the presence of the predetermined condition.

6. A signal processor receiving the encrypted data and including an apparatus for providing the number with random distribution according to claim 1.

7. The signal processor according to claim 6, comprising a pseudorandom number generator coupled to the apparatus and formed to receive the number from the apparatus and use the number as a seed for the pseudorandom number generator.

8. A method for providing a number with random distribution for use in a circuit including a signal processor processing encrypted data, comprising:
generating the number from at least a portion of the encrypted data received by the data the signal processor.

9. A program with a program code for performing a method for providing a number with random distribution for use in a circuit including a signal processor processing encrypted data, comprising: generating the number from at least a portion of the encrypted data received by the data the signal processor, when the program is run on a processor.

10. An electronic component comprising:
a data input/output for transmitting encrypted data; and
a circuit comprising:
a signal processor formed to process the encrypted data; and
an apparatus formed to provide a number with random distribution from at least a portion of the encrypted data processed by the signal processor for use in the circuit.

11. The electronic component of claim 10, wherein the electronic component is a chip card.
